(19) United States
(12) Patent Application Publication
(10) Pub. No.: US 2007/0057493 A1
(43) Pub. Date: Mar. 15, 2007

(54) Vehicle seat, in particular a sports seat

(75) Inventors: Michael Ritzel, Kirchheim unter Teck (DE); Ralf Vollweiter, Kirchheim unter Teck (DE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: RECARO GmbH & Co. KG

(21) Appl. No.: 11/520,557

(22) Filed: Sep. 13, 2006

(30) Foreign Application Priority Data
Sep. 14, 2005 (DE) 10 2005 044 012.6

(51) Int. Cl. B60R 21/16

(52) U.S. Cl. 280/730.2

(57) ABSTRACT

A vehicle seat (1), in particular a sports seat, has a seat (3), a backrest (4) and a side airbag module (14). A backrest shell (6) is the supporting structure of the backrest (4). A cover (20) is attached to the unupholstered and substantially uncovered outer side of the backrest shell (6). The side airbag module (14) is covered by the cover (20), and the cover (20) releases the side airbag module (14) when the side airbag module (14) is activated in response to a crash.

### RELATED APPLICATION

The present invention claims priority to DE 10 2005 044 012.6, which was filed Sep. 14, 2006. The entire disclosure of DE 10 2005 044 012.6 is incorporated herein by reference.

### BACKGROUND OF THE INVENTION

The present invention relates to a vehicle seat, in particular a sports seat, having a backrest shell, which is the supporting structure of the backrest, and a side airbag module, which is normally covered and then released when the side airbag module is activated in response to a crash.

Regarding vehicle seats in which a frame is the supporting structure for the backrest, it is known that the side airbag module has to be attached to the frame and is covered either by a covering section with tear seams, as, for instance, in DE 196 33 034 A1, or by a plastic plate with predetermined breaking points, as is apparent, for instance, in DE 196 42 938 C2. Regarding vehicle seats in which a backrest shell is the supporting structure of the backrest, it is known from DE 199 33 447 A1 that the side airbag module is attached to the side of the backrest shell that is opposite from the upholstery, with the side airbag module being covered with a plastic covering that is sown into the covering surrounding the backrest shell, and the plastic covering releasing the airbag when the airbag module is activated in response to a crash.

### BRIEF SUMMARY OF SOME ASPECTS OF THE INVENTION

In accordance with one aspect of the present invention, a vehicle seat, in particular a sports seat, includes a backrest shell, a side airbag module for activating in response to a crash, and a cover that covers the side airbag module and is operative for releasing the side airbag module in response to the side airbag module being activated. The backrest shell is the supporting structure of the seat's backrest, and the backrest shell includes an outer side that is unupholstered and substantially uncovered. The cover is attached to the unupholstered, substantially uncovered outer side of the backrest shell.

Since the cover is attached to the unupholstered and substantially uncovered outer side of the backrest shell, the side airbag module can be attached away from the upholstered part of the backrest and the cover can be designed as a separate component from the upholstered part of the backrest. In addition, it is possible to attach the cover so that it functions as a faceplate, which includes visible surfaces, for hiding the side airbag module from view. If necessary or desired, the cover can also hide an adapter, with the adapter attaching the backrest shell to a fitting (e.g., a pivotable fitting). Preferably, a customary (e.g., conventional) side airbag module that is designed to be mounted under a cover can be used.

In order to reduce weight and manufacturing costs, the cover is designed to be made from plastic materials, for instance, in the form of a box, preferably with the edges resting against the backrest shell and, consequently, thus being attached to and secured at the backrest shell. A predetermined breaking point, which will break after the side airbag module has been activated and which can be easily manufactured from plastic parts, preferably restricts at least one cover plate area of the cover. The cover plate area is movable after the predetermined breaking point has been broken (e.g., the cover plate area is at least further movable in response to the predetermined breaking point having been broken), with the cover plate area preferably pivoting around one hinge, for instance, a film hinge or another weakened area, in order to release the side airbag.

Other aspects and advantages of the present invention will become apparent from the following.

### BRIEF DESCRIPTION OF THE DRAWINGS

In the following, the invention is described in more detail with reference to the embodiment shown in the drawings, in which:

FIG. 1 is a rear perspective view of the embodiment;

FIG. 2 is a horizontal cross-sectional view of a portion of the embodiment in a normal case; and

FIG. 3 is a view like that of FIG. 2, except for being in the case of a crash.

### DETAILED DESCRIPTION OF EXEMPLARY EMBODIMENT

A vehicle seat 1 for a motor vehicle, which has been designed as a sports seat, includes a seat 3 and a backrest 4. The arrangement of the vehicle seat 1 in the vehicle and its usual moving direction define the directional indications used below. The supporting structure of the backrest 4 consists of a backrest shell 6. That is, the backrest shell 6 is for bearing the loads that are applied to the backrest 4, such as forces resulting from a crash. The backrest shell 6 is made from fiber-glass reinforced plastic (e.g., polymeric material), and is upholstered on the front or interior side, which is the side facing the passenger sitting in the seat 1. In contrast and in accordance with the exemplary embodiment of the present invention, the outer side of the backrest shell 6 (e.g., the rear side of the backrest shell 6) is not upholstered and it is also substantially uncovered, as will be discussed in greater detail below.

By way of pivotable fittings 8, the backrest 4 is pivotably mounted to the opposite sides of the seat 3. More specifically, a lower part of each fitting 8 is attached to the seat 3, and an upper part of each fitting is attached to the backrest 4. In greater detail for each fitting 8, the upper part of the fitting is attached to an elongate, somewhat sword-like adapter 12 that preferably consists of metal. The adapter 12, in turn, rests with its surface against, and is laterally connected to the unupholstered and substantially uncovered outer side of the backrest shell 6. Even more specifically and in accordance with the exemplary embodiment, although the backrest shell 6 is highly contoured, the adapter 12 is typically fastened to a flat region of the backrest shell 6. This mounting method is known from WO 2004/113114 A2 which corresponds to US 2006/082208 A1. The entire disclosures of WO 2004/113114 A2 and US 2006/082208 A1 are incorporated herein by reference.

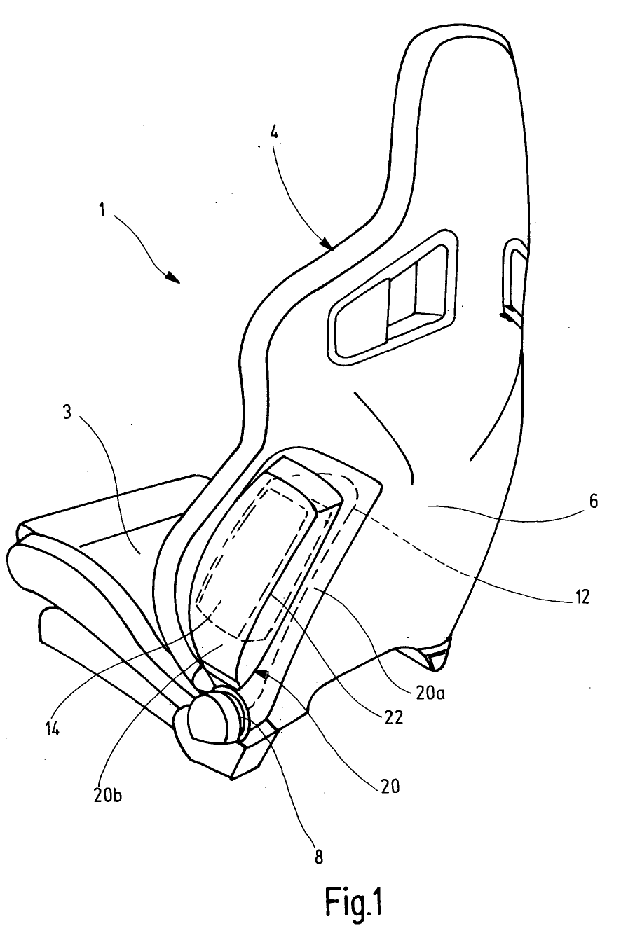

The backrest shell 6 is preferably a single piece that is contoured so that the backrest shell includes at least an upper pair of side cheeks that are integral parts of the backrest shell and extend outwardly at respective opposite sides of the backrest shell, and a lower pair of side cheeks that are integral parts of the backrest shell and extend outwardly at the respective opposite sides of the backrest shell. The upper pair of side cheeks are typically for supporting the shoulders of a user, whereas the lower pair of side cheeks are typically for supporting the user's torso/pelvis. The lower pair of side cheeks is typically shaped at least a little bit differently than the upper pair of side cheeks. As best understood with reference to FIG. 1, the upper part of the backrest shell 6 is in the form of a headrest, such that the headrest is an integral part of the backrest shell. Alternatively, the backrest shell 6 can be shaped differently than described above (e.g., the integral headrest can be omitted).

At least one side of the vehicle seat 1 has a generally known side airbag module 14, which has been designed to be mounted under a cover. By itself, the airbag module 14 and the manner in which it activates in response to a crash will be understood by those of ordinary skill in the art. The airbag module 14 is attached to the side of the vehicle seat 1 by way of a connector 16 mounted to the adapter 12. Alternatively, the airbag module 14 is attached directly to the backrest shell 6.

In the normal case (that is, not in the case of a crash), the side airbag module 14 is covered by a cover 20. That is and in accordance with the exemplary embodiment, the side airbag module 14 is hidden from view in FIG. 1; the side airbag module is schematically illustrated by dashed lines in FIG. 1. The cover 20 preferably consists of plastic (e.g., polymeric material) and is designed as a faceplate (that is, the outside of the cover 20 is provided with visible surface(s), e.g. surface(s) of the cover 20 typically are visible after the seat 1 has been fully assembled/while the seat is in its fully assembled configuration). The cover 20 is a relatively hard box that also covers the attached adapter 12, so that the adapter 12 does not need an additional faceplate. That is and in accordance with the exemplary embodiment, the adapter 12 is hidden from view in FIG. 1; the adapter is schematically illustrated by dashed lines in FIG. 1.

At least the major part of the edge areas of the cover 20 rest against the outer side of the backrest shell 6. A forward edge of the cover 20 extends upward in the vicinity of an edge of the backrest shell 6. This forward edge of the cover 20 is spaced slightly rearwardly of the edge of the backrest shell 6 so as to allow (e.g., not unduly interfere with) the attachment of the upholstery to the backrest shell. An upper edge of the cover 20 is positioned above the adapter 12 and extends rearwardly toward the farthest back part of the backrest shell 6. A rear edge of the cover 20 extends downwardly along the back side of the backrest shell 6. A lower edge of the cover 20 extends generally forwardly and across the adapter 12, with the lower edge of the cover being positioned slightly above the fitting 8 (e.g., when the fitting 8 is designed for being manually operated, the lower edge of the cover can have a curved section that extends partially around a shaft that extends inwardly from a handwheel for being manually operated, as shown in FIG. 1). These edges of the cover 20, or at least some of these edges of the cover 20, are attached, preferably screwed, to the backrest shell 6. More specifically, these edges of the cover 20, or at least some of these edges of the cover 20, are attached, preferably screwed, to the unupholstered and substantially uncovered outer side of the backrest shell 6. Accordingly and in accordance with the exemplary embodiment, the unupholstered and substantially uncovered outer side of the backrest shell 6 is partially covered (e.g. a portion of the unupholstered and substantially uncovered side of the backrest shell 6 is covered by the adapter 12, connector 16, airbag module 14 and cover 20); nonetheless, a vast majority of the unupholstered and substantially uncovered outer side of the backrest shell 6 is uncovered.

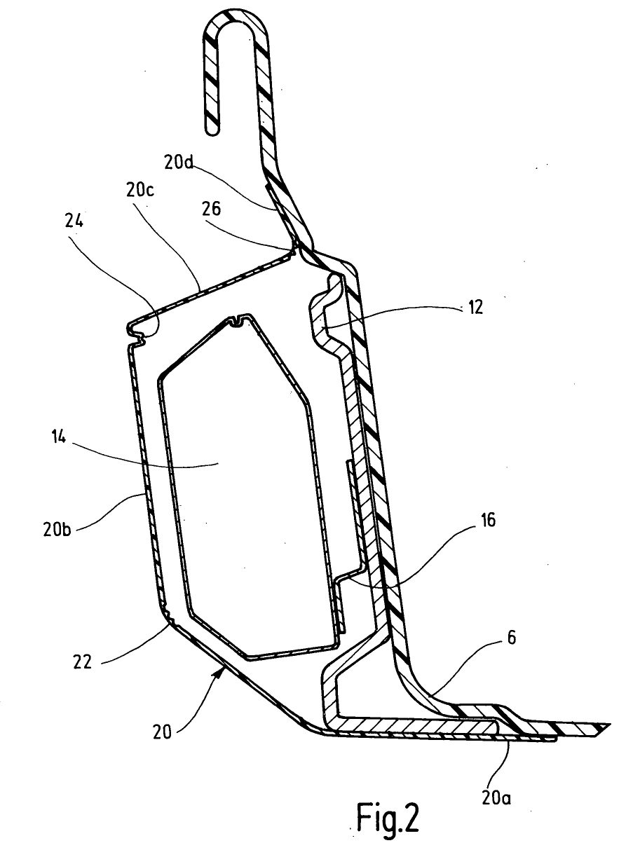

As shown in the sectional view of FIG. 2, the cover 20 extends from a rear edge area 20a that is approximately an extension of the back side of the backrest shell 6, then diagonally toward the front to an area that is weakened by material thickness reduction and serves as a first hinge 22, continuing to a first cover plate area 20b, which is arranged almost parallel to the respective portion of the backrest shell 6, to a predetermined breaking point 24 (e.g., a predetermined breaking area) of approximately 0.5 mm thickness (which can also be designed as a tear seam), then via a second cover plate area 20c, which extends toward the backrest shell 6, to another area that is weakened by material thickness reduction and serves as a second hinge 26, which is attached to a front edge area 20d located at the backrest shell. Above and below the side airbag module 14, the predetermined breaking point 24 extends to the hinges 22 and 26.

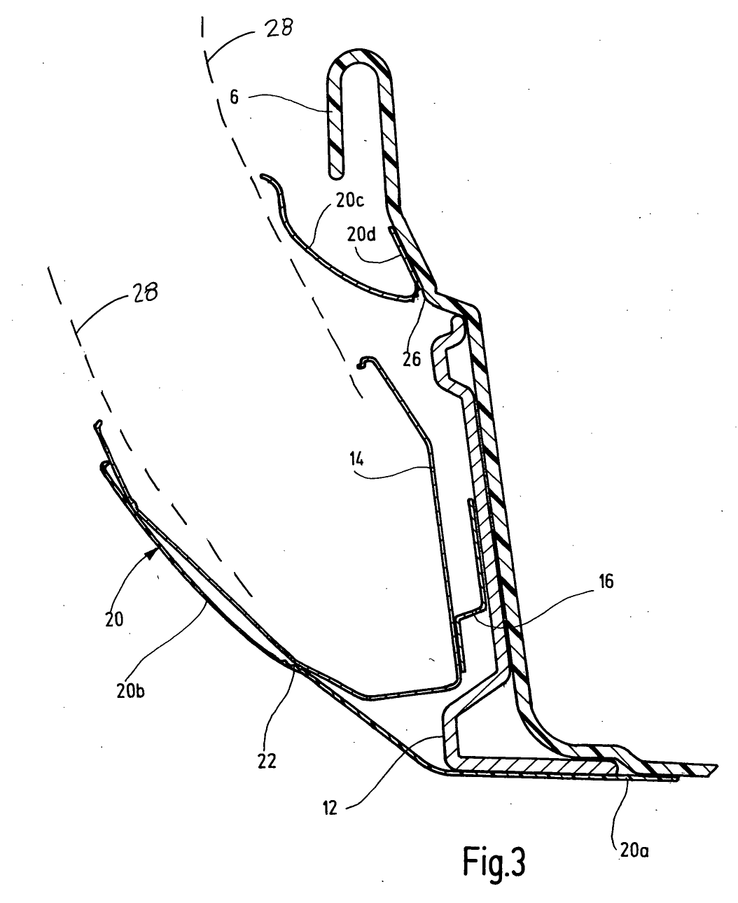

If, in case of a crash, the side airbag module 14 is activated and the side airbag 28 opens. A portion of the opened side airbag 28 is schematically illustrated by dashed lines in FIG. 3. In response to the side airbag module 14 being activated, the cover 20 releases the airbag module 14 by way of breaking of the predetermined breaking point 24, so that the two cover plate areas 20b and 20c, which are initially at least partially restricted by the predetermined breaking point 24, swivel (e.g., pivot) outwardly. That is, the first cover plate area 20b pivots around the first hinge 22, and the second cover plate area 20c pivots around the second hinge 26. The dimensions of the cover 20 and its partitions have been calculated in such a way that the side airbag 28 can open easily at the edge of the backrest shell 6.

FIGS. 2 and 3 are schematic because, for example, only a portion of the opened airbag 28 is schematically illustrated by dashed lines in FIG. 3, and the airbag 28 is not shown in FIG. 2. The side airbag module 14 includes a housing (shown in cross-section in FIGS. 2 and 3, and schematically illustrated by dashed lines in FIG. 1) that contains, or at least partially contains, the airbag 28 prior to the crash. As shown in FIGS. 2 and 3, the housing of the side airbag module 14 includes a predetermined breaking point or other type of openable feature that opens to release the airbag 28 in response to the crash.

It will be understood by those skilled in the art that while the present invention has been discussed above with reference to an exemplary embodiment, various additions, modifications and changes can be made thereto without departing from the spirit and scope of the invention as set forth in the following claims.

That which is claimed:

1. A vehicle seat for operating advantageously in the event of a crash, the vehicle seat comprising:
a seat;
a backrest, wherein the backrest includes a supporting structure, the supporting structure comprises a backrest shell, and the backrest shell includes an outer side that is unupholstered and substantially uncovered;
a side airbag module for activating in response to the crash; and
a cover attached to the unupholstered, substantially uncovered outer side of the backrest shell, wherein
the side airbag module is covered by the cover, and
the cover is operative for releasing the side airbag module in response to the side airbag module being activated.

2. The vehicle seat according to claim 1, wherein:
the cover comprises a box;
the box includes edge areas; and
at least some of the edge areas rest against the backrest shell and are connected to the backrest shell.

3. The vehicle seat according to claim 1, wherein the cover comprises a faceplate with visible surfaces.

4. The vehicle seat according to claim 1, wherein the side airbag module is configured for mounted behind a covering.

5. The vehicle seat according to claim 1, wherein the cover includes:
at least one predetermined breaking point that is operable for breaking in response to the side airbag module being activated, and
at least one cover plate area that is configured for becoming at least further movable in response to the at least one predetermined breaking point being broken.

6. The vehicle seat according to claim 5, wherein:
the cover includes a hinge;
the hinge is a weakened area of the cover; and
the cover plate area is configured for pivoting by way of the hinge after the at least one predetermined breaking point has been broken.

7. The vehicle seat according to claim 1, wherein the cover comprises plastic.

8. The vehicle seat according to claim 1, further comprising:
at least one fitting that is operatively connected between the backrest and the seat so that the backrest can be pivoted relative to the seat; and
at least one adapter, wherein the fitting is attached to the backrest shell by way of the adapter.

9. The vehicle seat according to claim 8, wherein the cover simultaneously covers the adapter and the side airbag module.

10. The vehicle seat according to claim 8, further comprising a connector, wherein the side airbag module is attached to the adapter by way of the connector.

11. The vehicle seat according to claim 2, wherein the box is not rectangular.

12. The vehicle seat according to claim 2, wherein the box includes:
at least one predetermined breaking point that is operable for breaking in response to the side airbag module being activated, and
at least one cover plate area that is configured for becoming at least further movable in response to the at least one predetermined breaking point being broken.

13. The vehicle seat according to claim 12, wherein:
the box includes a hinge;
the hinge is a weakened area of the box; and
the cover plate area is configured for pivoting by way of the hinge after the at least one predetermined breaking point has been broken.

14. The vehicle seat according to claim 3, wherein the cover includes:
at least one predetermined breaking point that is operable for breaking in response to the side airbag module being activated, and
at least one cover plate area that is configured for becoming at least further movable in response to the at least one predetermined breaking point being broken.

15. The vehicle seat according to claim 14, wherein:
the cover includes a hinge;
the hinge is a weakened area of the cover; and
the cover plate is configured for pivoting by way of the hinge after the at least one predetermined breaking point has been broken.

16. The vehicle seat according to claim 2, further comprising:
at least one fitting that is operatively connected between the backrest and the seat so that the backrest can be pivoted relative to the seat; and
at least one adapter, wherein
the fitting is attached to the backrest shell by way of the adapter, and
the box simultaneously covers the adapter and the side airbag module.

17. The vehicle seat according to claim 3, further comprising:
at least one fitting that is operatively connected between the backrest and the seat so that the backrest can be pivoted relative to the seat; and
at least one adapter, wherein
the fitting is attached to the backrest shell by way of the adapter, and
the cover simultaneously covers the adapter and the side airbag module.

18. The vehicle seat according to claim 2, wherein the box has one or more surfaces that are visible while the seat is in a fully assembled configuration.

19. The vehicle seat according to claim 18, wherein the box includes:
at least one predetermined breaking point that is operable for breaking in response to the side airbag module being activated, and
at least one cover plate area that is configured for being pivoted open after the at least one predetermined breaking point has been broken.

20. The vehicle seat according to claim 19, further comprising:
at least one fitting that is operatively connected between the backrest and the seat so that the backrest can be pivoted relative to the seat; and
at least one adapter, wherein
the fitting is attached to the backrest shell by way of the adapter, and
the box simultaneously covers the adapter and the side airbag module.
